(19) United States
(12) Patent Application Publication
(10) Pub. No.: US 2012/0025034 A1
(43) Pub. Date: Feb. 2, 2012

(54) PIPE SUPPORT

(76) Inventor: Thomas TURNER, Twinsburg, OH (US)

(21) Appl. No.: 12/846,098

(22) Filed: Jul. 29, 2010

(51) Int. Cl. F16L 3/08

(52) U.S. Cl. 248/65

(57) ABSTRACT

A one-piece pipe support having a base and an integral channel that can receive the ends of a pipe clamp in order to fasten the clamp to the base without the use of fasteners, such as bolts, screws, washers, etc.

### BACKGROUND OF THE INVENTION

The present invention relates generally to pipe supports, and, more specifically, to pipe supports for supporting pipes, such as gas lines, etc. on building roofs.

A known pipe support system consists generally of a hollow rubber block that rests on the roof below the object to be supported. A metal channel is secured to the block by screws, and a pipe clamp capable of being clamped around a pipe is engaged in the channel.

With the described pipe support system there is a danger of the metal channel rusting and separating from the support block over time. Other disadvantages of the conventional system are due to the use of steel screws or bolts and washers that fasten the channel to the block. They add to the cost of the system and the time required for installation.

### SUMMARY OF THE INVENTION

An object of the invention is to provide a pipe support that avoids the use of a metal channel with its attendant disadvantages.

A more specific object of the invention is to provide a novel support and pipe clamp arrangement consisting of a one-piece triangular base made of a rubber-like material having an integral channel in its top that is adapted to receive and secure a standard pipe clamp.

The new system avoids the use of screws, bolts, and washers, and is easier to install and less expensive than the conventional system having a base member and a separable metal channel.

### BRIEF DESCRIPTION OF THE DRAWINGS

FIG. 1 is a perspective view of the base member of the invention: and,

FIG. 2 is a perspective view showing a pipe clamp engaged in the base member.

FIG. 3 is an end elevation of the assembly shown in FIG. 3.

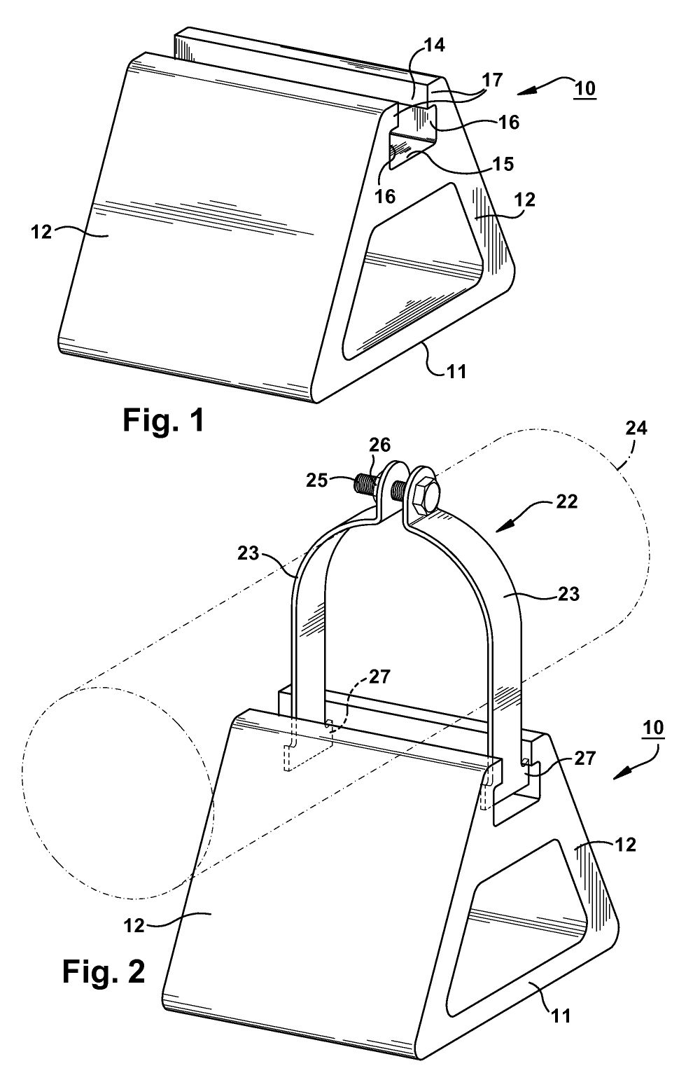

### DESCRIPTION OF THE PREFERRED EMBODIMENT

Referring to the drawing 3, reference 10 designates a one-piece support member formed of rubber-like material that is resistant to water and sunlight. The illustrated member 10 is triangular in cross-section and has a platform base 11 that will rest on a roof, and converging sides 12.

An integral channel 14 is formed in the top of the support member 10. The channel 14 has a bottom wall 15, side walls 16, and spaced apart lips 17.

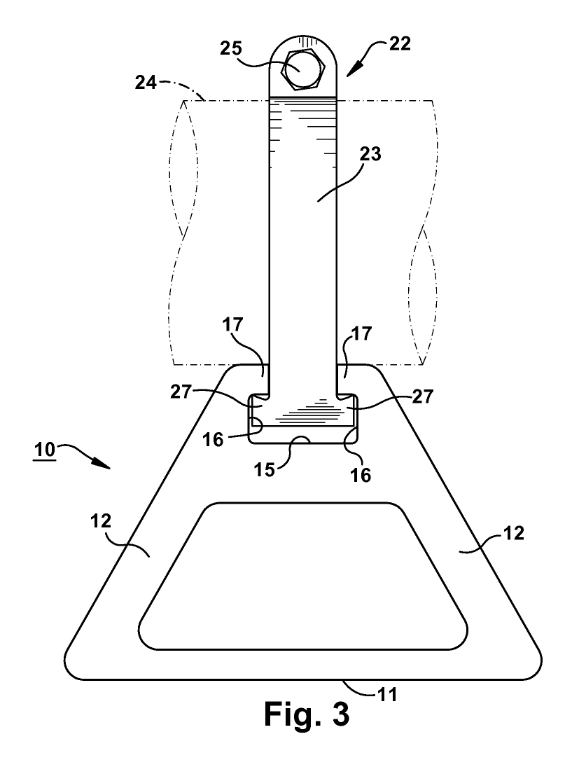

FIGS. 2 and 3 shows a pipe clamp 22 coupled to the support member 10. The clamp 22, which can be made of electro-galvanized steel, has two curved legs 23 that embrace a pipe shown in broken lines at 24. Two corresponding ends of the legs 23 are connected by a bolt 25 and nut 26. The other ends of the legs 23 are on opposite sides of the pipe 29 and have ears 27 engaged in the base channel 14 underneath the lips 11. The nut 26 can be adjusted on the bolt 25 in order to clamp pipes of different diameters.

As will be apparent from the foregoing, the pipe support of the invention does not have the conventionally used metal channel that must be fastened to a base. The one-piece support features an integral channel in which a pipe cleaner can be easily installed, and is resistant to rust and deterioration through use.

1-3. (canceled)

4. In a pipe support system comprising a support member made of rubber-like weather-resistant material which is adapted to rest on a mounting surface, and a channel in a top portion of said member for receiving a pipe clamp having T-shaped ends, the improvement wherein said member and said channel constitute a one-piece, integral formation with said channel having its walls formed by said weather-resistant material, said channel having a flat bottom wall, side walls at right angles to said bottom wall, and inwardly facing lips above said bottom wall.

5. The improvement as claimed in claim 4 wherein said support member is triangular shaped and has a platform base and sides converging from said base to said top portion in which said channel is formed.
